(19) United States
(12) Patent Application Publication
(10) Pub. No.: US 2020/0265629 A1
(43) Pub. Date: Aug. 20, 2020

(54) SYSTEMS AND METHODS FOR ANIMATION ON STRUCTURAL FEATURES USING ELECTRONIC INK

(71) Applicant: Universal City Studios LLC, Universal City, CA (US)

(72) Inventors: Steven C. Blum, Orlando, FL (US); Brian Birney McQuillian, Orlando, FL (US)

(21) Appl. No.: 16/793,952

(22) Filed: Feb. 18, 2020

Related U.S. Application Data
(60) Provisional application No. 62/808,156, filed on Feb. 20, 2019.

(51) Int. Cl. G06T 13/80; G09G 5/36

(52) U.S. Cl. CPC G06T 13/80; G09G 2300/026; G09G 5/36

(57) ABSTRACT

An entertainment imagery system including a structure that incorporates a display and a sensor that operates to detect activity. The display includes an electronic ink system that operates to provide animation on the display via transitioning electronic ink particles within the electronic ink system. A controller of the entertainment imagery system operates to control the electronic ink system to provide the animation in coordination with the activity detected by the sensor.

### CROSS-REFERENCE TO RELATED APPLICATIONS

This application claims priority from and the benefit of U.S. Provisional Application Ser. No. 62/808,156, entitled “ANIMATED FIGURE SYSTEMS AND METHODS,” filed Feb. 20, 2019, which is hereby incorporated by reference.

### BACKGROUND

The present disclosure relates generally to the field of amusement parks. More specifically, embodiments of the present disclosure relate to systems and methods utilized to provide heightened amusement park experiences with immersive effects.

Amusement parks and other entertainment venues contain, among many other attractions, animated figures that entertain and interact with park guests. For example, animated figures may entertain guests while the guests are waiting in queues or supplement ride experiences to provide more immersive experiences to guests. In other examples, animated figures may move around the amusement park, provide entertainment, and otherwise interact with guests. Certain animated figures may include components of a performer's costume, such as an animated head that covers the performer's face. It is now recognized that providing improved realism and immersive characteristics for such animated figures and other amusement park features is desired.

### BRIEF DESCRIPTION

Certain embodiments commensurate in scope with the originally claimed embodiments are summarized below. These embodiments are not intended to limit the scope of the claimed embodiments, but rather these embodiments are intended only to provide a brief summary of possible forms of the claimed embodiments. Indeed, the present disclosure may encompass a variety of forms that may be similar to or different from the embodiments set forth below.

In an embodiment, an entertainment system includes an animated figure. A component of the animated figure includes a display with an electronic ink system. Further, the entertainment system includes a controller configured to operate the display to provide animated imagery via the display of the component of the animated figure.

In an embodiment, an entertainment imagery system includes a sensor configured to detect activity and a structure incorporating a display. The display includes an electronic ink system configured to provide animation on the display via transitioning of electronic ink particles within the electronic ink system. The entertainment imagery system also includes a controller configured to control the electronic ink system to provide the animation in coordination with the activity detected by the sensor.

In an embodiment, a building structure animation system includes a plurality of displays incorporated with walls of the structure, wherein each of the plurality of displays includes an electronic ink system and a power supply configured to cooperate to present animation, via transitioning of electronic ink particles within the electronic ink system, on the walls of the building structure. A controller of the building structure animation system is configured to receive an indication of detected activity and to control at least a portion of the plurality of displays to coordinate the animation with the detected activity.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic representation of an embodiment of a system including an animated figure with a display that employs animation using an electronic ink system, in accordance with embodiments of the present disclosure; and

FIG. 2 is a schematic representation of a display including an electronic ink system coupled to a substantial power supply, in accordance with embodiments of the present disclosure.

### DETAILED DESCRIPTION

The present disclosure relates to amusement parks. More specifically, the present disclosure relates to systems and methods related to controlling visual aspects associated with animated figures and other amusement park features (e.g., buildings). Specifically, for example, present embodiments include systems for providing animated facial figures that utilize electronic ink and/or electronic paper to provide a desired aesthetic and that enable viewing without backlighting, projection mapping, and/or other features of traditional techniques.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

Present embodiments incorporate one or more features to provide more realistic imagery and characteristics to structural features (e.g., an androids face), which may enhance the experience of a guest attending an amusement park. Present embodiments may be incorporated into structural features of an animated figure (e.g., an android or robot), structural features of an animated costume piece (e.g., a character head worn by a performer with actuation mechanisms), or other features to facilitate displaying a variety of realistic expressions (e.g., moving facial features, transitioning skin features) or effects (e.g., cracks forming in a building). The use of electronic ink and/or electronic paper to display animated characteristics and features may be combined with a library of animations (e.g., database or selection menu of animations) stored in and accessible from a controller to provide a unique and immersive interactive experience.

The animations may be generated through the use of electronic ink and/or electronic paper to provide the illusion of feature movement, active textures, and the like. In contrast to traditional techniques, mechanical actuation and lighting features (e.g., liquid crystal displays, projection mapping) may be avoided. For example, traditional techniques often employ mechanical actuation of features, such as solenoid activation of a mechanical mouth or eyes, whereas present embodiments would replace or supplement this actuation with animation provided via a series of displays using animated ink to create animation. This may reduce or avoid the complexity and overhead associated with installation and repair of mechanical components involved with such traditional approaches. As another example, traditional techniques often employ projection mapping or backlit displays, which may include projecting imagery onto a rear portion of a translucent surface (e.g., a character face) to provide animation. Such traditional techniques often require a specific type of lighting (e.g., dimmed lighting) in the surrounding area to avoid issues associated with observing the animation. For example, if surrounding light is too bright (e.g., bright daylight), it reduces visibility of the projected imagery because it is overpowered by the brighter light in the surroundings. Present embodiments can employ electronic ink technology that is visible to guests in a wider range of lighting conditions. For example, lighting used for regular props can be used because the electronic ink is visible based on reflection of light. Furthermore, present embodiments may replace traditional projection mapping used on large structures, such as buildings to present desired effects. By utilizing electronic ink, present embodiments will allow for similar (yet more realistic) implementation of such effects while more light (e.g., broad daylight) is available. Traditional projection mapping is done while it is dark so the imagery projected on the structures is more readily visible.

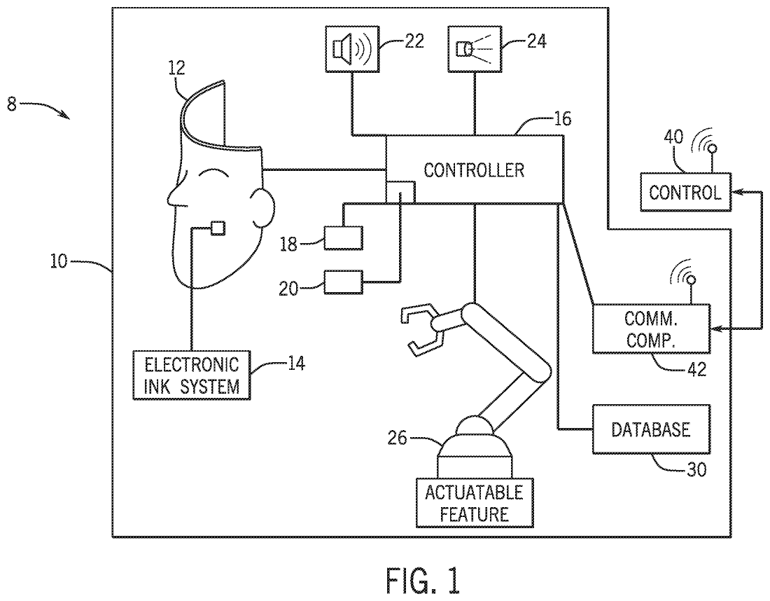

FIG. 1 is a schematic representation of an embodiment of a system 8 including an animated FIG. 10 with a display 12 (e.g., shaped to represent a desired feature) that employs animation using electronic ink and/or electronic paper, in accordance with embodiments of the present disclosure. It should be noted that the terms electronic ink and electronic paper generally reference a technology that can operate to electronically mimic or simulate ink disposed on paper, as will be discussed in further detail below. Thus, in the present disclosure, both electronic ink and electronic paper may be referred to as simply electronic ink. While, as noted above, electronic ink is generally used to mimic ink disposed on paper, this technology also includes embodiments that can mimic or simulate various different types of presentation substances disposed on an actual substrate. For example, multi-colored presentations are available, not merely traditional ink disposed on white paper.

Ink is one example of a presentation substance, as the terminology is used in the present disclosure. For example, in accordance with the present disclosure, a presentation substance may include ink, paint, dye, lead, and so forth. Further, paper is one example of a substrate, as the terminology is used in the present disclosure. For example, in accordance with the present disclosure, a substrate may include paper, cloth, wood, dirt, brick, and so forth. In accordance with present embodiments, various techniques can be employed to mimic a desired presentation substance and substrate. For example, in some embodiments, the electronic ink may include characteristics (e.g., may be activated in a pattern) that suggests dyed paper, chipped paint, rust, pigment, charcoal, or the like. To further enhance certain characteristics, a screen or film through which the electronic ink is displayed may be textured to represent a desired substrate. For example, the screen may include a wood grain or fibrous texture to mimic wood or cloth, respectively.

In the illustrated embodiment, the display 12 is shaped to represent a single face. However, the illustration of the display 12 in FIG. 1 is representative and does not limit the nature of the display 12. Indeed, the display 12 is intended to represent any of numerous different physical features or structures that would benefit from animation provided by electronic ink, in accordance with the present disclosure. The display 12, which may include a specific geometry and/or texturing to represent a desired feature, also includes an electronic ink system 14. The electronic ink system 14 can be activated to present a series of images via the display 12 in rapid succession to provide animation. For example, facial expressions may be represented on the display 12 by controlling the electronic ink system 14 to present pixilated colors in desired sequences.

A controller 16 of the system may include a processor 18 that is operable to execute instructions stored in a memory 20 to perform operations, such as determining animations to execute on the display 12 via the electronic ink system 14 and executing the animations in the referenced manner. The processor 18 may represent any number of processors and the memory 20 may represent any number of memories. As such, in some embodiments, the controller 16 may include one or more general purpose microprocessors, one or more application specific processors (ASICs), one or more field programmable logic arrays (FPGAs), or any combination thereof. Additionally, the memory 20 (one or more memories) may be a tangible, non-transitory (not merely a signal), computer-readable medium that stores instructions executable by the processor 18 (one or more processors) and data to be processed by the processor 18. Thus, in some embodiments, the memory 20 may include random access memory (RAM), read only memory (ROM), rewritable non-volatile memory, flash memory, hard drives, optical discs, and the like.

The controller 16 may be employed to control the electronic ink system 14 and the corresponding animation. In certain embodiments, the controller 16 may also control other associated effects to coordinate a cumulative effect. For example, in the illustrated embodiment, the controller 16 may be operable to control sound generators 22 (e.g., speakers), lighting 24 (e.g., spotlights, pyrotechnics), and actuatable features 26 (e.g., robotics, actuators) to present a combined effect. Specifically, for example, the controller 16 could operate to move a robotic body (as represented by actuatable feature 26) of an android to flail arms in conjunction with an animated expression of surprise being presented on a face of the android (as represented by the display 12) via the electronic ink system 14. Similarly, desired lighting effects and sound effects may be coordinated via control of the sound generators 22 and lighting 24 by the controller 16. The controller 16, which may be representative of a single controller (e.g., programmable logic controller) or a system of controllers (e.g., numerous controllers in a network) may control other features as well. For example, the controller 16 may control a ride system in conjunction with other aspects of the system 8.

In certain embodiments, the controller 16 may store data related to animations in a library of animations. Such data may be stored in the memory 20. However, in some embodiments, storage may be provided by a separate database 30 in addition to or separate from the memory 20. The animations may include different sets of instructions or routines for controlling the electronic ink system 14 to provide desired outputs (e.g., animations of a face changing expressions, skin changing colors, muscles flexing, and cracks forming). Thus, present embodiments may play back stored animation scenarios with electronic ink presented via a physical structure (e.g., a face of an animated figure or a building), such as that represented by the display 12. Furthermore, other routines may be stored to facilitate presentation of desired effects. For example, routines or sets of instructions (e.g., motion profiles) associated with movements of actuatable features, light control, and sound control may be stored by the controller 16 and/or database 30 and implemented by the controller 16.

As noted above, the electronic ink system 14 may be controlled to coordinate with actuatable features 26 to provide a combined effect. The actuatable features 26 may include any suitable actuators, such as electromechanical actuators (e.g., linear actuator, rotary actuator), robotic components, and so forth. The actuatable features 26 may be located inside of a sheath (e.g., a rubber skin) and be configured to adjust certain features or portions of the animated figure. In some embodiments, the display 12 may include flexible components configured to be manipulated in a similar manner. Likewise, various displays 12 may also be actuated along with provision of animation of the displays 12 to provide an effect. For example, a particular display (e.g., the display 12) shaped like a head, an appendage, or an animal may be moved by actuators in combination with animation being presented on the particular display via an associated electronic ink system (e.g., the electronic ink system 14) to provide an overall effect (e.g., the impression of a character laughing and dancing). As another example, various displays having different shapes (e.g., members of a character's body) may be coordinated together with animation to provide a combined effect (e.g., a character turning into a werewolf).

In the illustrated embodiment, the system 8 also includes a base station control system 40 (e.g., remote control system). The base station control system 40 is an example of a remote access point for user interaction and management with the controller 16. While wired and/or wireless communication may be employed, in the illustrated embodiment, both wired and wireless communication is received from the base station control system 40 by a communication component 42 of the controller 16. In some embodiments, two-way communication is performed to facilitate the provision of feedback between the base station control system 40 and the controller 16. Thus, the communication component 42 provides instructions or data to the base station control system 40. It should be understood that the illustrated system is merely intended to be exemplary, and that certain features and components may be omitted and various other features and components may be added to facilitate performance, in accordance with the disclosed embodiments.

Furthermore, the communication component 42 may enable the controller 16 to interface with various other electronic devices beyond just the base station control system 40. For example, the communication component 42 may enable the controller 16 to communicatively couple to a network, such as a personal area network (PAN), a local area network (LAN), and/or a wide area network (WAN). In further embodiments, the controller 16 may be communicatively coupled via a wired (e.g., land line) or wireless connection to the various components of the system 8, such as the electronic ink system 14. Accordingly, in some embodiments, the controller 16 may process data received by the communication device 42 from a remote input and respond to the input by modifying aspects of the system 8, such as animation presented via the electronic ink system 14 and the display 12. For example, a user may use an input device (e.g., a keyboard) of the base station control system 40 to transmit data or instructions via the communication component 42 to cause activation of animation via the display 12 and electronic ink system 14 in conjunction with a motion profile for the actuatable feature 26.

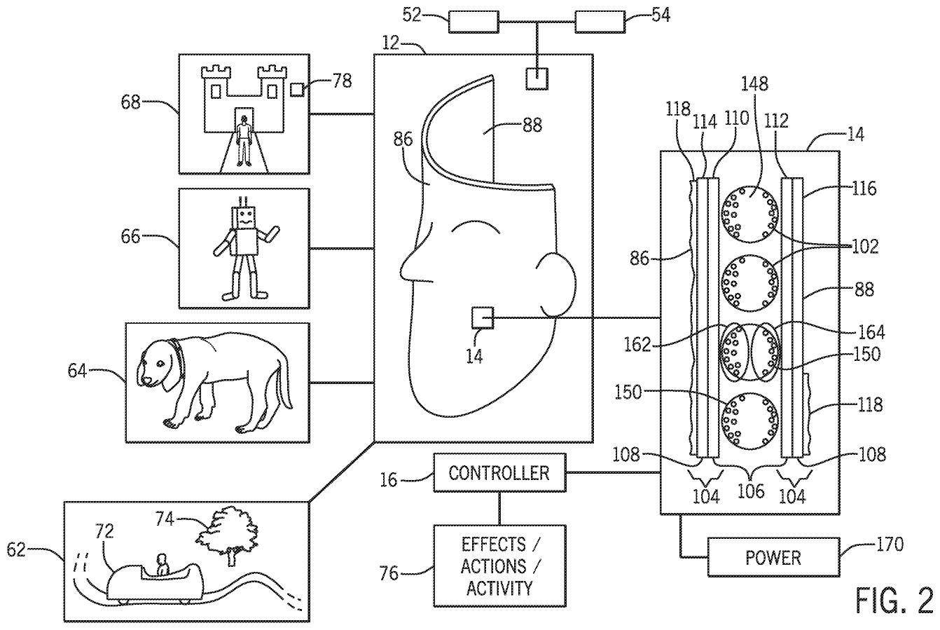

FIG. 2 is a schematic representation of the display 12, which includes the electronic ink system 14 in accordance with embodiments of the present disclosure. In the illustrated embodiment, the display 12 and electronic ink system 14 may be integral with a processor 52 and a memory 54. However, in other embodiments, these are separately provided in a computer or control device, such as the controller 16 in the previously described embodiment. As with FIG. 1, the display 12 illustrated in FIG. 2 is presented as a structure having a mask or face form factor. Thus, the illustrated display 12 and electronic ink system 14 may be employed to provide animated facial features in accordance with present embodiments. However, as previously noted, the form of the display 12 may be different in other embodiments. To illustrate this, different display shapes are illustrated in FIG. 2. Specifically, examples including a ride system 62, an animal FIG. 64, a robot or android 66, and a building structure 68 are represented. Each of these display structures may be utilized as the display 12. Further, certain aspects of each display structure may be controlled differently. For example, in one embodiment, a ride vehicle 72 and a scenery 74 of the ride system 62 may each be separately controlled such that each separately displays a particular fixed color, fixed pattern, animated pattern, animated scene or the like using respective control features (e.g., the controller 16) to manage respective electronic ink systems 14. In some embodiments, the ride system 62 may also include animated figures that employ displays and integral electronic ink systems that operate in accordance with present embodiments to facilitate immersion in the ride environment. The various types of displays 12 may be managed by the controller 16 in coordination with other activity 76 (e.g., detected or initiated effects or actions) to provide combined effects. For example, a building structure 68 may be animated based on detected weather. Specifically, a weather sensor 78 may detect a strong wind and provide data indicative of the strong wind to the controller 16, which may utilize an algorithm or database and the provided data to identify a corresponding animation (e.g., animated shingles appearing to blow off the building) to present via the display 12, which is integral to the building structure 68. In other examples, the animation may show melting features in hot weather or cracking features in cold weather based on algorithms and/or databases that correlate detected weather with animations. In another embodiment, the ride vehicle 72 and/or the scenery 74 may be modified based on a position of the ride vehicle 72 along its route. A preprogrammed or detected ride path or ride profile may be utilized to identify a position of the ride vehicle 72, and the imagery may be adjusted based on the position. As a specific example, a monitored location of the ride vehicle 72 may trigger the controller 16 to manage the display 12, which is integral to the ride vehicle 72, to display animated water effects when the ride vehicle 72 is going through a water-themed portion of a related ride path. Other coordinated effects may include actuators of a robot (e.g., head movement) in conjunction with feature animations (e.g., animated facial expressions), animated fur bristling in conjunction with sound effects, and the like. Each of these animations may be correlated with detected or instructed actions based on programmed algorithms (e.g., processor executable instructions) or databases.

FIG. 2 also illustrates a schematic representation of components of the electronic ink system 14, in accordance with present embodiments. Specifically, FIG. 2 illustrates a schematic cross-sectional view of a portion of the display 12, which depicts separate components of an embodiment of the electronic ink system 14 and how they interact. An outward facing side 86 of the display 12 represents a side of the display 12 that is generally intended to be observed by a guest and an inward facing side 88 of the display 12 represents a back side or portion that is generally not intended to be observed by the guest. However, in some embodiments, both sides may be viewable by guests and may be intended as such.

The illustrated components of the electronic ink system 14 combine to provide what may be referred to as a film of microcapsules with electronic ink particles that are charged and can be rearranged electronically to display desired content (e.g., animations). The illustrated components include electronic ink capsules 102 disposed between panels 104 that each include a film 106 and an electrode 108. Specifically, in the illustrated embodiment, a first film 110 is disposed along the outward facing side 86 of the illustrated portion of the display 12 and a second film 112 is disposed along the inward facing side 88 of the illustrated portion of the display 12 such that the first film 106 and the second film 112 are facing one another on inward parts of the respective outward and inward facing sides 86, 88. Further, a first electrode 114 is disposed adjacent the first film 110 toward an outer part of the outward facing side 86 of the display 12 and a second electrode 116 is disposed adjacent the second film 112 toward an outward part of the inward facing side 88 of the display 12. The first electrode 114 is a transparent or translucent electrode to facilitate viewing of the electronic ink capsules 102. Depending on the embodiment, the second electrode 116 may be transparent, translucent, or opaque. In the illustrated embodiment, a textured screen 118 is also provided on the outward facing side 86 of the display 12. This textured screen 118 may provide additional immersive effects, such as a texturing filter of the imagery provided by the electronic ink system 14. For example, the textured screen 118 may provide the look of wood grain, scales, or the like. Another textured screen 118 (of the same or different texture) may be used on the inward facing side 88 as well. In either case, the textured screen 118 may fully cover or partially cover the outward facing or inward facing side 86, 88, respectively.

The films 106 and electrodes 108 of the panels 104, along with the textured screen 118, are illustrated as generally planar. However, this is intended to be a representation of relatively small components of an overall shape. The overall shape may include contours that form an overall display geometry (e.g., a face, vehicle, door). The overall display geometry may include any of various structures that would benefit from animation provided in accordance with present embodiments. For example, the illustrated cutout of the components of the electronic ink system 14 in FIG. 2 may represent a small cross-sectional portion of the display 12, which includes a mask or face, as illustrated. It should be noted that millions of the electronic ink capsules 102 may be employed to form a single display 12. Numerous electronic ink capsules 102 may be utilized to provide a single pixel on the display 12.

The electronic ink capsules 102 each include a fluid 148 (generally a clear fluid) and electrically charged particles 150, which may be referred to as electronic ink particles 150. The electronic ink particles 150 are suspended in the fluid 148, which allows them to transition within the electronic ink capsules 102 based on control features related to activation of electric fields within the electronic ink system 14. Because the electronic ink particles 150 are charged, activation of the first electrode 114 and/or the second electrode 116 impacts the positioning of the electrically charged particles 150. For example, in a black and white display, a first set 162 of the electrically charged particles 150 may be positively charged white particles and a second set 164 of the electrically charged particles 150 may be negatively charged black particles. The electronic inks capsules 102, including the fluid 148 and the electronic ink particles 150 are sandwiched between the first and second electrodes 114, 116, which may be divided up into regions that correspond to pixels of the display 12. Thus, in response to charging of the electrodes (or electrode regions), the ratios of visible electronic ink particles 150 in each region change. For example, when the second electrode 116 is generating a positive electric field, the first set 162 of the electronic ink particles 150 is pushed toward the outward facing side 86 of the display 12 and obscures the second set 164 of the electronic ink particles 150 that has been pushed to the inward facing side 88 of the display 12. In the illustrated embodiment, the first set 162 is being repelled by the second electrode 116 and the second set 164 is not. In this example, a white pixel would be generated. If a negative electric field is generated by the second electrode 116, the opposite arrangement would be caused and a black pixel generated. If a mixture of electric fields is generated by the second electrode 116, a mixture of black and white will be provided as the pixel color. In other embodiments, other colors may be employed to provide imagery in numerous different color combination of pixels.

Electronic ink technology uses a limited amount of power relative to most display systems because it essentially only uses power to change the polarity of electrodes on a per-region basis. Thus, a single image can be sustained for a long period without requiring additional power. However, to facilitate animation using electronic ink technology, a substantial amount of power may be required because constant updating of the imagery is required to provide animation. Accordingly, present embodiments may include a coupling to a substantial power source 170 (e.g., a source coupled to an electric grid), as illustrated in FIG. 2. By directly coupling the display 12 to the substantial power source 170, present embodiments can achieve desired animation effects.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

While only certain features of the present disclosure have been illustrated and described herein, many modifications and changes will occur to those skilled in the art. Further, it should be understood that components of various embodiments disclosed herein may be combined or exchanged with one another. It is, therefore, to be understood that the appended claims are intended to cover all such modifications and changes as fall within the true spirit of the disclosure.

1. An entertainment system, comprising:
an animated figure;
a component of the animated figure comprising a display with an electronic ink system; and
a controller configured to operate the display to provide animated imagery via the display of the component of the animated figure.

2. The system of claim 1, wherein the animated figure comprises an android, the component comprises a head of the android, and a geometry of the display corresponds to that of a mask.

3. The system of claim 1, wherein the display comprises a transparent or translucent textured layer disposed on an outward facing side of the display.

4. The system of claim 1, wherein the electronic ink system includes electronic ink capsules sandwiched between transparent or translucent films.

5. The system of claim 4, wherein the electronic ink system includes the electronic ink capsules and films sandwiched between transparent or translucent electrodes.

6. The system of claim 1, comprising actuatable features configured to be controlled by the controller, wherein the controller is configured to coordinate a motion profile of the actuatable features with the animated imagery.

7. The system of claim 1, comprising actuatable features configured to be controlled by the controller, wherein the controller is configured to correlate actuator actions with the animated imagery.

8. The system of claim 7, wherein the controller comprises a processor and a memory, wherein the memory is a tangible, non-transitory, computer-readable medium storing processor-executable instructions to perform an algorithm or search a database to identify the animated imagery based on the actuator actions.

9. The system of claim 1, wherein the electronic ink system is coupled to a power grid to facilitate animation of the display via the electronic ink system.

10. An entertainment imagery system, comprising:
a sensor configured to detect activity;
a structure incorporating a display;
an electronic ink system of the display configured to provide animation on the display via transitioning of electronic ink particles within the electronic ink system; and
a controller configured to control the electronic ink system to provide the animation in coordination with the activity detected by the sensor.

11. The system of claim 10, wherein the structure comprises a face of an animated figure and the sensor is configured to detect activity including movement of actuators configured to move body features of the animated figure.

12. The system of claim 11, wherein the controller is configured to activate the electronic ink system to provide facial expression animations on the display in response to the activity detected by the sensor including movement of actuators associated with limbs of the animated figure.

13. The system of claim 10, wherein the sensor comprises a weather sensor and the controller is configured to activate the electronic ink system to provide a particular animation on the display based on detection by the sensor of the activity including a type of weather.

14. The system of claim 13, wherein the sensor comprises a wind sensor, a rain sensor, or a temperature sensor.

15. The system of claim 10, wherein the display comprises a texturing layer on an outward-most face of the display.

16. The system of claim 10, wherein the structure is a component of a ride vehicle of a ride system, scenery of the ride system, or both.

17. The system of claim 16, wherein the controller is configured to control the animation on the display based on the activity detected by the sensor including activity of the ride vehicle within the ride system.

18. The system of claim 17, wherein the activity comprises the ride vehicle arriving at a position along a ride path.

19. A building structure animation system, comprising:
a plurality of displays incorporated with walls of a structure, wherein each display of the plurality of displays includes an electronic ink system and a power supply configured to cooperate to present animation, via transitioning of electronic ink particles within the electronic ink system, on the walls of the structure; and
a controller configured to receive an indication of detected activity and to control at least a portion of the plurality of displays to coordinate the animation with the detected activity.

20. The system of claim 19, comprising a sensor configured to detect weather and provide data regarding the weather as the indication of the detected activity to the controller, wherein the controller is configured to control the animation based on the detected weather.
